(19) United States
(12) Patent Application Publication
(10) Pub. No.: US 2017/0351562 A1
(43) Pub. Date: Dec. 7, 2017

(54) METHOD FOR PROCESSING AT LEAST ONE PIECE OF INFORMATION IN A NETWORKED SYSTEM

(71) Applicant: Robert Bosch GmbH, Stuttgart (DE)

(72) Inventor: Marc Neufeld, Ludwigsburg (DE)

(21) Appl. No.: 15/533,413

(22) PCT Filed: Jan. 4, 2016
(86) PCT No.: PCT/EP2016/050008

§ 371 Date: Jun. 6, 2017

(30) Foreign Application Priority Data
Jan. 19, 2015 (DE) 102015200721.9

(51) Int. Cl. G06F 11/07; G05B 15/02

(52) U.S. Cl. CPC G06F 11/0751; G06F 11/0793; G06F 11/0709; G05B 15/02

(57) ABSTRACT

A method for processing at least one information item in a networked system to yield a result, the at least one information item, which encompasses a value and a validity of the value, being transferred from at least one source of the system to a receiver of the system, an interim data set having at least two variables being used, of which a first variable is allocated to the value of the at least one information item, and a further variable is allocated to the validity of the value, and at least one evaluating step being carried out in the receiver, using the value and the validity, in order to determine a resultant data set having a resultant value and a resultant validity as a result of the processing of the at least one information item.

### FIELD

The present invention relates to a method for processing at least one information item in a networked system and to a networked system, and to a calculation unit and a computer program for carrying out the method.

### BACKGROUND INFORMATION

When different information sources are networked, for example for the so-called “internet of things,” the result is that data and/or information items that are obtained from external sources are normally regarded as valid directly after they are transferred, and are checked for validity and plausibility only later on in processing.

For example, according to the CAN protocol it is a principle of information transfer between two control units of a motor vehicle that the transmitting control unit vouches for the validity of the transmitted data and/or information items.

Control units of this kind process large volumes of signals that derive from external sources, for example sensors or interfaces. Those signals are combined during processing steps, and the result is then used for decisions upon software execution or in order to apply control to actuating members. Digital signals (logical zero=invalid, logical one=valid) or discrete status variables (invalid, initialized, . . . , valid), which characterize the validity status, can be used partly in parallel with the variables used for that purpose in the software.

During initialization of the control units and in the event of a fault in the external sources (e.g. due to a sensor failure, delays in the interface, etc.), in real-time systems initial and substitute values are typically used for further data processing.

It is often not possible to determine, based on the input variables of a control unit, whether or not a signal or a value ascertained in that control unit is trustworthy at the current time, since no information regarding their validity exists for those variables.

A need therefore exists to demonstrate ways in which the validity of at least one information item can be taken into consideration upon processing thereof.

### SUMMARY

According to the present invention, an example method for processing at least one information item in a networked system, and a networked system, as well as a calculation unit and a computer program for carrying out the method are provided. Advantageous embodiments are described herein.

In order to process at least one information item in a networked system to yield a result, the at least one information item is transferred from at least one source of the system to a receiver of the system. An interim data set having at least two variables is used, of which a first variable is allocated to a value of the at least one information item, and a further variable is allocated to the validity of the value. At least one evaluating step is carried out in the receiver, using the value and the validity, in order to determine a resultant data set having a resultant value and a resultant validity as a result of the processing of the at least one information item. The resultant validity thus makes available a value with which the validity of the resultant value can be assessed. This allows the result to be assessed as to whether or not it is valid, i.e. correct or trustworthy. The validity indicates, for example whether what was intended to be calculated or measured was in fact calculated or measured, or whether or not the information items obtained are also in fact correct.

Preferably, in a comparing step, the validity is compared with a minimum value, and the interim data set and/or the resultant data set are determined as a function of the comparison result. This makes it possible to react effectively, in the context of processing, to information items having insufficient validity.

Preferably a substitute value is used as a value of the at least one information item for the interim data set if the validity is less than or equal to the minimum value. It is thereby possible, for example, to prevent possibly erroneous values from leading to an undesired result, or to prevent possibly faulty values from being unrestrictedly further processed or forwarded as valid values. The substitute value can advantageously be a reliable standard value for the respective source. Alternatively, it can also be the most recent valid value, or an average of several most recent valid values.

The substitute value is preferably a value from a different source having a higher validity. If the validity is too low, information values of further sources are therefore evaluated so as therefore to find a value having a higher validity.

According to a further embodiment the resultant value is determined only when the value of the validity is greater than or equal to the minimum value. This ensures that values that are to be categorized as very uncertain, because of their low validity, cannot be further processed and thus lead to incorrect results.

According to an embodiment, a confidence value relating to the respective source is allocated by the receiver to the at least one source. A confidence value that does not derive from the source itself, and is thus source-independent, is thus used. Malfunctions of the source itself thus cannot lead to an erroneously high confidence value.

According to a further embodiment, the confidence value is used in order to determine the resultant validity. The confidence value is thus incorporated into the resultant validity, so that the resultant validity depends not only on the validity of the value but also on the confidence value of the source. A particularly accurate resultant validity is thus furnished.

According to a further embodiment, the validity can have values between one and zero. The value zero can be allocated to an absence of validity, and the value one to a validity verging on certainty. Validity values less than one and greater than zero characterize a lower or unknown validity of the data or of the result. This permits particularly simple processing of the values for the validity.

The confidence value(s) of the source can furthermore analogously have values between one and zero. The value zero can be allocated to an absence of validity, and the value one to a confidence verging on certainty. This permits particularly simple processing of the confidence values.

In terms of the validity of the result, this means that low validity values close to zero occur when data sources with an unknown origin for the original data or an unclear data source state are used, or because the data source itself has evaluated the validity of the transmitted values to be less than one. High validity values of one or close to one, on the other hand, occur when known sources with a good knowledge of the state, i.e. a high confidence value for the data source, are used, and because the data source itself has evaluated the validity of the transmitted values to be one or very close to one.

A networked system, for example an electrical system of a motor vehicle, has as a calculation unit a control unit that is configured to carry out, in particular by programmed execution, a method according to the present invention. At least one source can be embodied as a sensor of a motor vehicle. The processing reliability of information items in a vehicle electrical system can be appreciably increased with such a system, so that the electrical system is, for example, less sensitive to electromagnetic interference signals and/or to a failure or malfunctions of components of the electrical system, e.g. sensors. Improvements are therefore achieved specifically in the safety-relevant sector of motor vehicle electrical systems.

Implementation of the method in the form of software is also advantageous, since this entails particularly low cost, especially if an executing control unit is also used for further tasks and is therefore present in any case. Suitable data media for furnishing the computer program are, in particular, diskettes, hard drives, flash memories, EEPROMs, CD-ROM, DVDs, and many others. Downloading of a program via computer networks (internet, intranet, etc.) is also possible.

Further advantages and embodiments of the present invention are described below and are shown in the figures.

It is understood that the features discussed above and those yet to be explained below are usable not only in the respective combination indicated but also in other combinations or in isolation, without departing from the scope of the present invention.

### BRIEF DESCRIPTION OF THE DRAWINGS

The present invention is schematically depicted in the figures on the basis of an exemple embodiment, and is described below with reference to figures.

FIG. 1 schematically depicts a networked system in which information items are processed to yield results.

FIG. 2 shows a value curve or signal curve for a first value of a first source, and a value curve for the first validity of the first value.

FIG. 3 shows a value curve or signal curve for a second value of a second source, and a value curve for the second validity of the second value.

FIG. 4 shows a curve for a resultant value and a curve for a resultant validity.

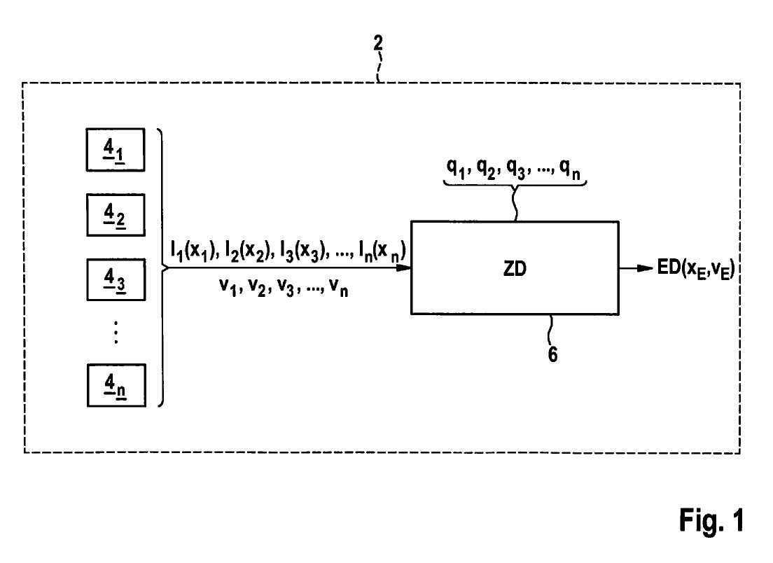

FIG. 1 depicts a networked system 2 for processing information items, which in the present exemplifying embodiment has a plurality of sources 4₁, 4₂, 4₃, . . . , 4ₙ and a receiver 6.

### DETAILED DESCRIPTION OF EXAMPLE EMBODIMENTS

In the present exemplifying embodiment, sources 4₁, 4₂, 4₃, . . . , 4ₙ can be intelligent or smart sensors or interfaces of an electrical system of a motor vehicle, while receiver 6 can be a control unit or a portion of a control unit of the motor vehicle.

From the respective sensors 4₁, 4₂, 4₃, . . . , 4ₙ, respective information items I₁, I₂, I₃, . . . , Iₙ are transferred to control unit 6, the respective information items I₁, I₂, I₃, . . . , Iₙ each having a value x₁, x₂, x₃, . . . , xₙ, for example a measured value of a sensor.

According to the embodiment shown, the respective validities v₁, v₂, v₃, . . . , vₙ relating to the values x₁, x₂, x₃, . . . , xₙ of information items I₁, I₂, I₃, . . . , Iₙ are also transferred from the respective sensors 4₁, 4₂, 4₃, . . . , 4ₙ to control unit 6. Information items I₁, I₂, I₃, . . . , Iₙ can have a vector format.

While values x₁, x₂, x₃, . . . , xₙ corresponding to sensors 4₁, 4₂, 4₃, . . . , 4ₙ can assume any values, for example in accordance with the measurement range of a sensor, the validities v₁, v₂, v₃, . . . , vₙ can assume, for example, values between zero and one. The value zero can be allocated to an unknown or low validity v₁, v₂, v₃, . . . , vₙ, and the value one to a validity v₁, v₂, v₃, . . . , vₙ verging on certainty. The validity v₁, v₂, v₃, . . . , vₙ indicates here whether, for example, what was intended to be measured was in fact measured, or whether or not the information items I₁, I₂, I₃, . . . , Iₙ obtained are in fact correct or derive from a trustworthy source.

Sensors 4₁, 4₂, 4₃, . . . , 4ₙ can be embodied, for example, as intelligent or smart sensors or interfaces, and can have a self-diagnosis function or plausibility checking function. Sensors 4₁, 4₂, 4₃, . . . , 4ₙ can thus, for example, detect their own malfunction or recognize implausible values. Alternatively or additionally, sensors 4₁, 4₂, 4₃, . . . , 4ₙ can be embodied for a measured data evaluation that checks a series of measured values in terms of plausibility, for example whether the measured values fluctuate excessively within a predetermined time interval, or whether multiple values are plausible with respect to one another.

In the present exemplifying embodiment a CAN bus system is used to transfer the information items I₁, I₂, I₃, . . . , Iₙ and validities v₁, v₂, v₃, . . . , vₙ from sensors 4₁, 4₂, 4₃, . . . , 4ₙ to control unit 6.

In addition to processing of the information items, the latter can also be displayed to a user or driver of the vehicle, for example on a display device. If the information items are made available on a display device, then in addition to the useful information item I the allocated validity value of the information item can additionally be displayed. If the information is organized in a sequenced list, the presentation can be organized by descending validity, so that information items having the highest validity are displayed first, and those having the lowest validity are displayed last.

Vehicle electrical system 2, sensors 4₁, 4₂, 4₃, . . . , 4ₙ, and/or control unit 6 have hardware and software components for this purpose and in order to process information items I₁, I₂, I₃, . . . , Iₙ.

Control unit 6 creates and uses an interim data set ZD having at least two variables. Of the two variables, a first variable is allocated to the value x₁, x₂, x₃, . . . , xₙ of the respective information item I₁, I₂, I₃, . . . , Iₙ, while a further variable is allocated to the validity v₁, v₂, v₃, . . . , vₙ of the respective value x₁, x₂, x₃, . . . , xₙ. The interim data set ZD can have a vector format.

Control unit 6 is embodied or configured to execute an evaluating step so that, using values x₁, x₂, x₃, . . . , xₙ and their validities v₁, v₂, v₃, . . . , vₙ, a resultant data set ED having a resultant value x_{E} and a resultant validity x_{E} are determined as a result. The resultant data set ED can have a vector format.

The evaluating step can encompass, for example, carrying out calculation operations using scalar variables, for example an addition involving the values x₁, x₂, and their validities v₁, v₂, of sensors 4₁, 4₂:

I₁⊕I₂=(x₁,v₁)⊕(x₂,v₂)=(x₁+x₂,v₁*v₂).

In the context of addition, the values x₁, x₂ are thus added, and their validities v₁, v₂, whose value is between zero and one, are multiplied, so that the value of the resultant validity v_{E} is always between zero and one.

The calculation operations can also encompass a multiplication involving the values x₁, x₂, and their validities v₁, v₂, of sensors 4₁, 4₂:

I₁ [symbol] I₂=(x₁,v₁) [symbol] (x₂,v₂)=(x₁*x₂,v₁*v₂).

In the context of multiplication, the values x₁, x₂ are thus multiplied, and their validities v₁, v₂, whose value is between zero and one in this case as well, are multiplied, so that here as well, the value of the resultant validity v_{E} is always between zero and one.

According to further preferred embodiments, the information items I₁, I₂, I₃, . . . , Iₙ can additionally have one or more further elements and can have, for example, the following vector format:

Iₙ=(xₙ,vₙ,qₙ,sₓ,nₓ,rₓ),

where qₙ can be a confidence value relating to the respective source, e.g., relating to a known source, a sensor value, an information item from a third-party source (e.g., government information, company information), etc., or a value between zero for an unknown source and one for a trustworthy source. A confidence value q₁, q₂, q₃, . . . , qₙ is thus allocated by the receiver of the respective source 4₁, 4₂, 4₃, . . . , 4ₙ and is used to determine the resultant validity v_{E}.

The evaluating step can encompass, for example, any calculation operations, for example any mathematical functions relating to the values x₁, x₂, . . . , xₙ and their validities v₁, v₂, . . . , vₙ and confidence values q₁, q₂, . . . , qₙ of sources 4₁, 4₂, 4₃, . . . , 4ₙ. The result represents a resultant value xₑ as a function fₓ of input values x₁, x₂, . . . , xₙ and of their validities v₁, v₂, . . . , vₙ confidence values q₁, q₂, . . . , qₙ, and a resultant validity vₑ as a function fᵥ of the input validities v₁, v₂, . . . , vₙ and confidence values q₁, q₂, . . . , qₙ:

F(I₁,I₂, . . . ,Iₙ)=F((x₁,v₁,q₁),(x₂,v₂,q₂), . . . ,(xₙ,vₙ,qₙ))==(fₓ(x₁,v₁,q₁,x₂,v₂,q₂, . . . ,xₙ,vₙ,qₙ),fᵥx(x₁,v₁,q₁,x₂,v₂,q₂, . . . ,xₙ,vₙ,qₙ))

In addition, sₓ can assume, for example, values which denote respective information items I₁, I₂, I₃, . . . , Iₙ that are obtained for the first time, obtained several times, confirmed by further sources, calculated, and/or valid.

In addition, nₓ can denote the number of utilized sources 4₁, 4₂, 4₃, . . . , 4ₙ which was used in order to determine the resultant validity v_{E}.

Lastly, rₓ can denote the number of sub-steps, having evaluating steps and optionally further processing steps, that were carried out starting from information items I₁, I₂, I₃, . . . , Iₙ up to the current result.

Receiver 6 can furthermore be embodied to carry out a comparing step, for example before the evaluating step. In the comparing step, a value of one of the validities v₁, v₂, v₃, . . . , vₙ is compared with a minimum value. The evaluating step for determining the resultant value x_{E} is performed only when the value of the validity v₁, v₂, v₃, . . . , vₙ is greater than or equal to the minimum value. The comparing step ensures that, for example, a value x₁ that is to be categorized as very uncertain, based on its low validity v₁, is not further processed and thus cannot lead to incorrect results.

In this case a fault signal can be generated, or the method is continued or repeated using a substitute value (e.g., standard value, average, moving average of earlier values having sufficient validity, etc.), as described below. For example, receiver 6 can be embodied to carry out a supplementing step, for example before the evaluating step but after the comparing step, the supplementing step being executed, for example, when the value of one of the validities v₁, v₂, v₃, . . . , vₙ is less than or equal to the minimum value, i.e. is to be categorized as very uncertain. In the supplementing step, further information items I₁, I₂, I₃, . . . , Iₙ from further sources 4₁, 4₂, 4₃, . . . , 4ₙ are read in by receiver 6, or transferred to receiver 6 from the further sources 4₁, 4₂, 4₃, . . . , 4ₙ, and then evaluated by receiver 6 in order to determine a further validity v₁, v₂, v₃, . . . , vₙ for the values x₁, x₂, x₃, . . . , xₙ that were read in or transferred.

What can possibly be achieved by way of the supplementing step is that the value of the further validity v₁, v₂, v₃, . . . , vₙ is greater than the threshold value, so that the resultant value x_{E} is then also determined.

The evaluating step and the optional comparing steps and supplementing steps can be sub-steps of a method, having multiple steps, for processing information items 4₁, 4₂, 4₃, . . . , 4ₙ in a networked system 2 to yield a result. Interim resultant data sets having interim resultant values and interim resultant validities can be created during each sub-step and are updated again in the subsequent sub-step.

Lastly, receiver 6 can be embodied to create a sequenced information item list. The sequenced information item list IL has a plurality of data sets, each data set having a value xₙ and the validity vₙ thereof:

IL={(x₁,v₁),(x₂,v₂), . . . ,(xₙ,vₙ)}

The data sets can be disposed in the sequenced information list IL, for example, in accordance with the magnitudes of the values of the respective validity v₁, v₂, v₃, . . . , vₙ. The value x₁ having the highest validity v₁ is thus in first place, followed by the value x₂ having the second-highest validity v₂, and so forth.

A sequenced information list IL of this kind can be created in particular when, for one of the values xₙ, its validity vₙ is greater than or equal to the minimum value, and that value xₙ with its validity vₙ would therefore not be taken into account in further processing.

For example, the sequenced information list IL with its individual data sets (i.e. value xₙ and validity vₙ) can be displayed to a user in accordance with its validity, for example in a sequence that begins with the value xₙ having the highest validity vₙ, followed by the value x₂ having the second-highest validity v₂, and so forth.

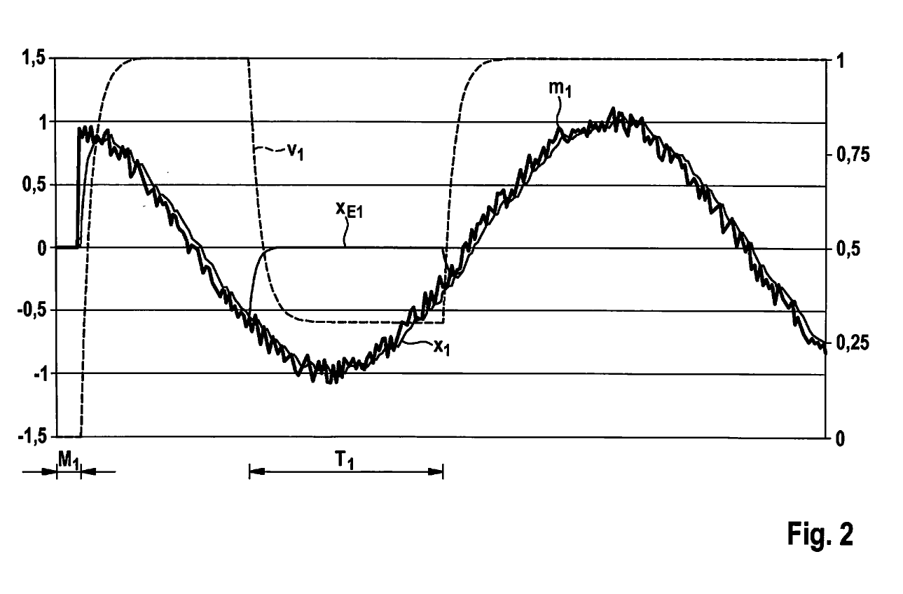

A method sequence will now be explained with additional reference to FIGS. 2 to 4.

FIG. 2 shows a curve m₁ for measured values as captured by sensor 4₁. This is, for example, a sensor having its own measured value conditioning system (smart sensor), which performs a filtration of the measured value curve, for example a smoothing, and, in the example shown, outputs the smoothed curve for first values x₁. The sensor can be, for example, a rotation angle measuring device that outputs a normalized measured signal [−1, . . . , +1], for example in accordance with a sine relationship.

FIG. 2 furthermore shows a curve v₁ for the validity of values x₁. A validity v, which describes the certainty or accuracy of the value, is allocated by sensor 4₁ to each value x that is to be outputted. The validity is between zero (uncertain) and one (certain), and can be ascertained by the sensor, for example, based on internal testing routines.

What is depicted is that at the beginning, sensor 4₁ requires a first minimum time period M₁, for example until a first zero crossing or the like, in order to furnish the first information item I₁. Sensor 4₁ accordingly outputs at the beginning, during the time span M₁, the value x₁=0 and validity v₁=0. Also depicted is the fact that during a later time span T₁, an uncertainty exists in the measured value conditioning, and sensor 4₁ accordingly reduces the validity to v₁=0.3.

The values x₁ and validities v₁ are transferred from sensor 4₁ to control unit 6. In the control unit, an interim data set ZD is created therefrom for further processing. Control unit 6 is furthermore embodied to carry out a comparing step before the evaluating step. In the comparing step, the validity v₁ is compared with a minimum value that, in the present example, is equal to more than 0.3. If the validity does not exceed the minimum value, then in accordance with the embodiment depicted here, calculation occurs in the control unit using a substitute value x_{E1}=0. This can be, for example, a reliable standard value for the respective sensor. It is thereby possible to prevent possibly erroneous values from leading to an undesired result.

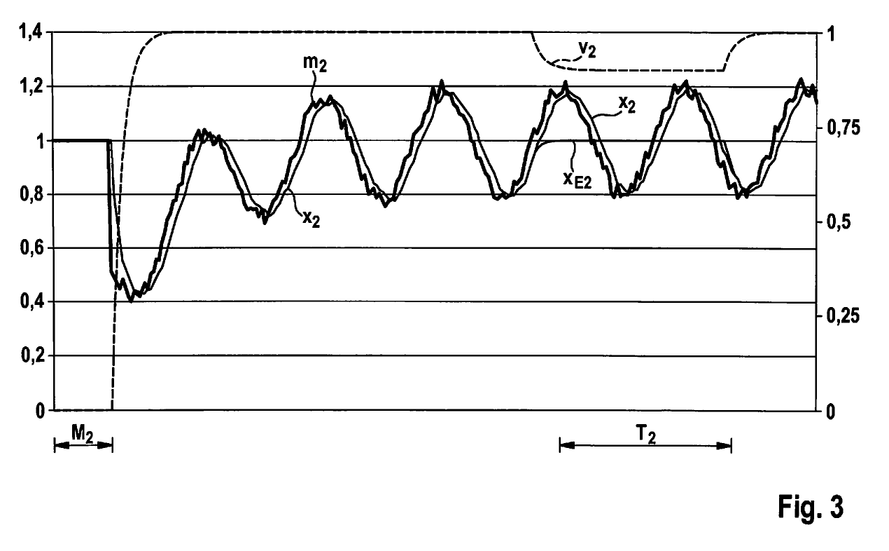

FIG. 3 depicts a similar case for a sensor 4₂ having a curve m₂ for measured values, a curve x₂ for second values, and a curve v₂ for second validities of the first value x₁.

What is depicted is that at the beginning, sensor 4₂ requires a second minimum time period M₂ in order to furnish the second information item I₁. Sensor 4₂ accordingly outputs at the beginning, during the time span M₂, the value x₂=1 and validity v₂=0. Also depicted is the fact that during a later time span T₂, an uncertainty exists in the measured value conditioning, and sensor 4₂ accordingly reduces the validity to v₂=0.9.

The values x₂ and validities v₂ are transferred from sensor 4₂ to control unit 6. In the control unit, an interim data set ZD is created therefrom for further processing. Control unit 6 is furthermore embodied to carry out a comparing step before the evaluating step. In the comparing step, the validity v₂ is compared with a minimum value that, in the present example, is equal to more than 0.9. If the validity does not exceed the minimum value, then in accordance with the embodiment depicted here, calculation occurs in the control unit using a substitute value x_{E2}=1. This can be, for example, a reliable standard value for the respective sensor. It can also be the most recent valid value or an average of several most recent valid values.

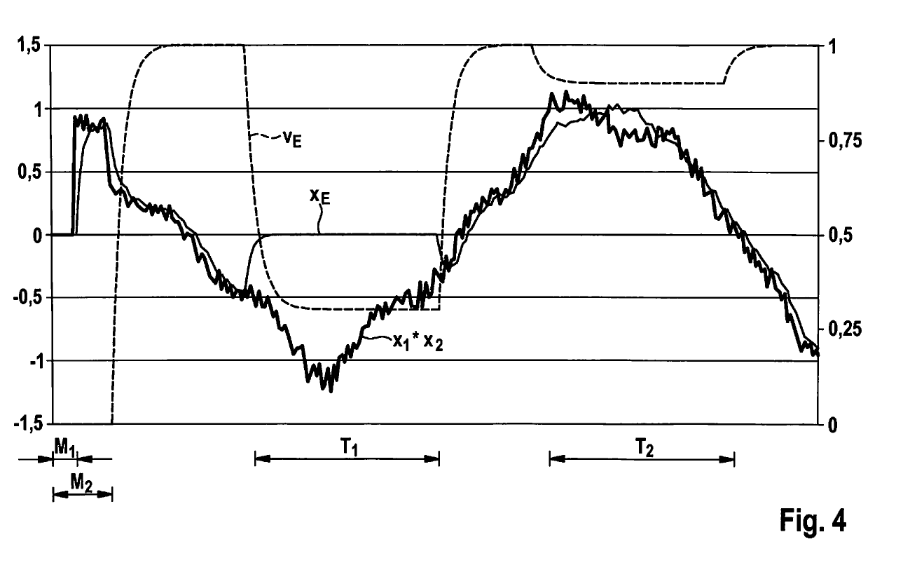

Control unit 6 is embodied or configured to perform an evaluating step in order to determine, using the values x₁ and x₂ or the respective substitute values x_{E1} and x_{E2} (the alternatives are represented by x_{(E)i}) and their validities v₁ and v₂, as a result of multiplying the two information items I₁ and I₂, a resultant data set ED having a resultant value x_{E} and a resultant validity v_{E}. An evaluating step of this kind is illustrated in FIG. 4, in which a multiplication of the values x₁ and x₂ is carried out.

Conventionally, the product x₁*x₂ would be calculated for this purpose. According to the embodiment of the invention which is presented, however, the validity is taken into consideration, as follows:

I₁ [symbol] I₂=(x_{(E)1},v₁) [symbol] (x_{(E)2},v₂)=(x_{(E)1}*x_{(E)2},v₁*v₂).

It is evident that the resultant validity v_{E}, constituting the product of validities v₁, v₂, is reduced, i.e. is less than one, during the first minimum time period M1, the second minimum time period M2, the first time interval T1, and the second time interval T2, while between the second minimum time period M2 and the first time interval T1, between the first time interval T1 and the second time interval T2, and after the second time interval T2, the resultant validity v_{E} is one.

The resultant value x_{E} is thus reliable and trustworthy between the second minimum time period M2 and the first time interval T1 and after the first time interval T1, and not trustworthy (vₑ=0) or partly trustworthy (0<vₑ<1) in the other time intervals.

What is therefore available with the resultant validity v_{E} is a value with which the validity of the resultant value x_{E} can be assessed. The resultant validity v_{E} indicates the trustworthiness of the processing result in the control unit.

1-13. (canceled)

14. A method for processing at least one information item in a networked system to yield a result, method comprising:
transferring at least one information item which encompasses a value, and a validity of the value from at least one source of the system to a receiver of the system;
using an interim data set having at least two variables, of which a first variable is allocated to the value of the at least one information item, and a further variable is allocated to the validity of the value; and
carrying out at least one evaluating step in the receiver, using the value and the validity, to determine a resultant data set having a resultant value and a resultant validity as a result of the processing of the at least one information item.

15. The method as recited in claim 14, further comprising:
comparing the validity with a minimum value, and at least one of the interim data set and the resultant data set being determined as a function of the comparison result.

16. The method as recited in claim 15, wherein a substitute value is used as a value of the at least one information item for the interim data set if the validity is less than or equal to the minimum value.

17. The method as recited in claim 16, wherein a value from a different source having a higher validity is used as the substitute value.

18. The method as recited in claim 15, wherein the resultant value is determined only when the validity is greater than or equal to the minimum value.

19. The method as recited in claim 14, wherein a confidence value relating to the respective source is allocated by the receiver to the at least one source.

20. The method as recited in claim 19, wherein the confidence value is used to determine the resultant validity.

21. The method as recited in claim 20, wherein the validity is capable of having values between one and zero.

22. The method as recited in claim 14, wherein a plurality of information items are transferred from a plurality of sources to the receiver of the system, a plurality of interim data sets being used, and the resultant data set, having a resultant value and a resultant validity being determined as a result of the processing of the plurality of information items.

23. A calculation unit that is configured to carry out a method for processing at least one information item in a networked system to yield a result, the calculation unit configured to:
transfer at least one information item which encompasses a value, and a validity of the value from at least one source of the system to a receiver of the system;
use an interim data set having at least two variables, of which a first variable is allocated to the value of the at least one information item, and a further variable is allocated to the validity of the value; and
carry out at least one evaluating step in the receiver, using the value and the validity, to determine a resultant data set having a resultant value and a resultant validity as a result of the processing of the at least one information item.

24. A networked system having a calculation unit, the calculation unit configured to carry out a method for processing at least one information item in a networked system to yield a result, the calculation unit configured to:
transfer at least one information item which encompasses a value, and a validity of the value from at least one source of the system to a receiver of the system;
use an interim data set having at least two variables, of which a first variable is allocated to the value of the at least one information item, and a further variable is allocated to the validity of the value; and
carry out at least one evaluating step in the receiver, using the value and the validity, to determine a resultant data set having a resultant value and a resultant validity as a result of the processing of the at least one information item.

25. A non-transitory machine-readable memory medium on which is stored a computer program for processing at least one information item in a networked system to yield a result, the computer program, when executed by a computer, causing the computer to perform:
transferring at least one information item which encompasses a value, and a validity of the value from at least one source of the system to a receiver of the system;
using an interim data set having at least two variables, of which a first variable is allocated to the value of the at least one information item, and a further variable is allocated to the validity of the value; and
carrying out at least one evaluating step in the receiver, using the value and the validity, to determine a resultant data set having a resultant value and a resultant validity as a result of the processing of the at least one information item.
